(19) United States
(12) Patent Application Publication
(10) Pub. No.: US 2005/0207639 A1
(43) Pub. Date: Sep. 22, 2005

(54) Inspection apparatus

(75) Inventors: Kazuhito Horiuchi, Hachioji-shi (JP); Haruyuki Tsuji, Ina-shi (JP)

Correspondence Address: FRISHAUF, HOLTZ, GOODMAN & CHICK, PC, 220 5TH AVE FL 16, NEW YORK, NY, 10001-7708, US

(73) Assignee: Olympus Corporation, Tokyo (JP)

(21) Appl. No.: 11/083,776

(22) Filed: Mar. 18, 2005

(30) Foreign Application Priority Data
Mar. 22, 2004 (JP) 2004-083567

(51) Int. Cl. G06K 9/00

(52) U.S. Cl. 382/149

(57) ABSTRACT

An inspection apparatus has a unit which calculates a luminance adjustment value to adjust a luminance of a first image at a desired value by use of image information on the first image, a storage unit which stores the calculated luminance adjustment value, a unit which searches the first image having image information corresponding to a second image different from the first image, a unit which reads out a luminance adjustment value corresponding to the searched first image from the storage unit, and a unit which adjusts a luminance of the second image based on the luminance adjustment value read out from the storage unit.

### CROSS-REFERENCE TO RELATED APPLICATIONS

This application is based upon and claims the benefit of priority from prior Japanese Patent Application No. 2004-083567, filed Mar. 22, 2004, the entire contents of which are incorporated herein by reference.

### BACKGROUND OF THE INVENTION

1. Field of the Invention

The present invention relates to an inspection apparatus, particularly to an inspection apparatus for performing appearance inspection of a semiconductor wafer.

2. Description of the Related Art

The following method is generally employed as a method for inspecting an appearance of a semiconductor wafer. Two two-dimensional images, which are originally identical, are captured by an optical unit. Two detected images, which are obtained by the image-capturing, are compared to detect a different portion in these detected images as a defect. In this manner, conventionally, a differential image between the compared images is calculated to detect a portion where a differential image luminance level is large as a defect.

In the above appearance inspection, as a technique for performing an image processing of detecting a pattern defect without being affected by brightness or distortion of an image, the following technique has been known. In this technique, luminance level of patterns contained in two detected images to be compared, which are originally identical, are corrected and luminance level correction is preformed to decrease a luminance level difference so that the luminance level difference can be recognized to be normal even when the luminance level difference is present at non-defect portions (refer to Jpn. Pat. Appln. KOKAI Publication No. 10-253544).

Furthermore, the following pattern inspection technique is also known (refer to Jpn. Pat. Appln. KOKAI Publication No. 11-304718). A first inspected pattern is detected to obtain a first image of the first inspected pattern. This first image is stored, and a second inspected pattern is detected to obtain a second image of this second inspected pattern. Then, a tone of at least one of the images is converted such that the brightness of the stored first image and the second image becomes substantially identical, and the first image and the second image, which are adjusted in the brightness, are compared.

As described above, the brightness of the images are adjusted, thereby preventing erroneous detection. However, in the case of inspecting objects to be inspected or in the case where a user uses an inspection image group for inspecting operation information or inspect performance, it is necessary not only to adjust the two images in the brightness but also to make the brightness of the two images appropriate. Thus, the two images are adjusted to have appropriate brightness in this manner, thereby performing optimum inspecting.

### BRIEF SUMMARY OF THE INVENTION

An object of the present invention is to provide an inspection apparatus for comparing an inspected image with a reference image to inspect a status of a defect in the inspected image, wherein luminance levels of the reference image and the inspected image are adjusted to be both appropriate, thereby performing accurate inspection.

An inspection apparatus according to one aspect of the present invention is characterized by comprising: a unit which calculates a luminance adjustment value to adjust a luminance of a first image at a desired value by use of image information on the first image; a storage unit which stores the calculated luminance adjustment value; a unit which searches the first image having image information corresponding to a second image different from the first image; a unit which reads out a luminance adjustment value corresponding to the searched first image from the storage unit; and a unit which adjusts a luminance of the second image based on the luminance adjustment value read out from the storage unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a schematic configuration of an inspection apparatus to which the present invention is applied;

FIG. 2 is a flowchart of a luminance adjustment processing in a defect determination processing in the inspection apparatus;

FIG. 3 is a flowchart showing details of a portion where a luminance adjustment value is set from a notice image in a reference pattern;

FIG. 4A to FIG. 4C are explanatory diagrams of an image area used in histogram generation;

FIG. 5A to FIG. 5C are explanatory diagrams of an image area used in histogram generation;

FIGS. 6A to 6D are diagrams showing examples of various histograms.

FIGS. 7A to 7E are diagrams showing other adjusting methods in the case where a luminance adjustment value from a histogram is set;

FIG. 8 is a flowchart which shows an operation of an inspection apparatus according to another embodiment of the present invention; and

FIG. 9 is an explanatory figure of an operation of the inspection apparatus according to another embodiment of the present invention.

### DETAILED DESCRIPTION OF THE INVENTION

Embodiments according to the present invention will be described with reference to the drawings.

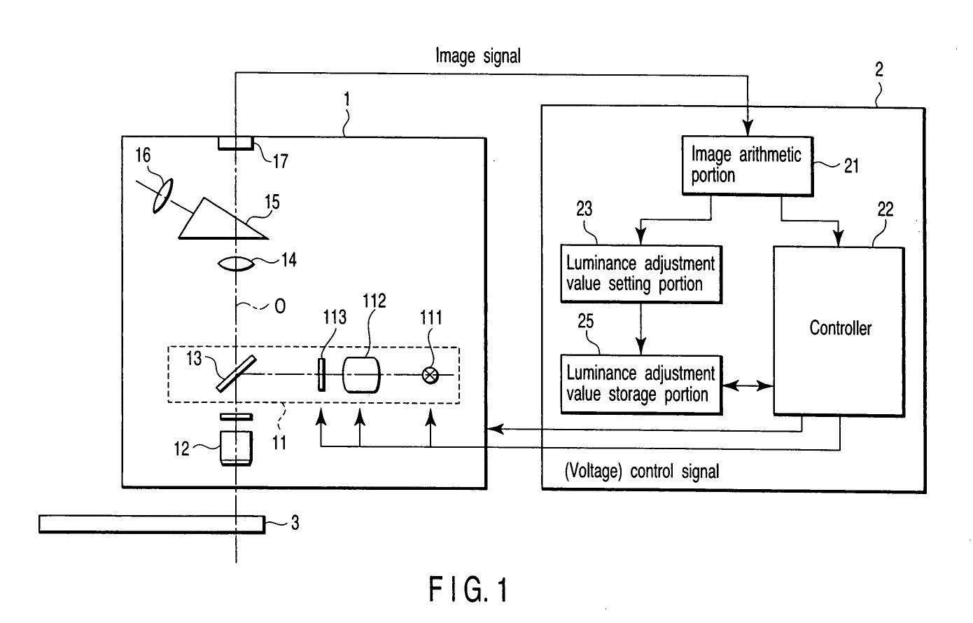

FIG. 1 is a diagram showing a schematic configuration of an inspection apparatus to which the present invention is applied. The inspection apparatus shown in FIG. 1 is applied to an optical device (inspection microscope).

The inspection apparatus shown in FIG. 1 comprises an inspection microscope 1 and an arithmetic processing unit 2.

The inspection microscope 1 irradiates a semiconductor wafer 3 for observation (hereinafter, simply referred to as “wafer”) via an objective lens 12 by a illumination light projecting tube 11. A reflected light from the wafer 3 is observed by an eyepiece lens 16 and is captured by an imaging device 17 such as CCD. An image signal captured by the imaging device 17 is output to the arithmetic processing unit 2. The arithmetic processing unit 2 arithmetically processes the image captured by the imaging device 17 and performs luminance setting or the like based on the arithmetic result.

A schematic operation of the inspection apparatus in FIG. 1 will be described.

An irradiated light from a light source 111 of the illumination light projecting tube 11 is reflected toward the objective lens 12 at a polarized beam splitter 13 which is an optical path division element via an image forming lens 112 and an ND filter 113, and then reaches the wafer 3 via the objective lens 12.

The light incident into the wafer 3 is reflected at the wafer 3 and again passes through the polarized beam splitter 13 via the objective lens 12, and is visually observed by an observer at the eyepiece lens 16 via a relay lens 14 and a prism 15. The imaging device 17 for observed image acquisition is arranged on the extension of an observation optical path O, and the light which has passed through the polarized beam splitter 13 passes through the prism 15 or bypasses the same from the observation optical path O to be captured by the imaging device 17.

An image output from the imaging device 17 is input into an image arithmetic portion 21 of the arithmetic processing unit 2. The image arithmetic portion 21 uses a non-defect image (hereinafter, referred to as “reference image”) captured by the imaging device 17 to calculate luminance information. When luminance adjustment is needed for the reference image or the inspection image, a controller 22 generates a voltage control signal for changing a transmittance of the ND filter 113 or a power voltage of the light source 11 to transmit the same to a drive motor of the ND filter 113 (or the power of the light source 11). For example, the drive motor is rotated at a predetermined angle based on the voltage control signal so that the transmittance of the ND filter 113 is changed.

On the other hand, a luminance adjustment value setting portion 23 sets the luminance adjustment value (here, the voltage control signal for changing the transmittance of the ND filter 113) such that the luminance adjustment is appropriate, and a luminance adjustment value storage portion 25 stores therein the luminance adjustment value when appropriately adjusted. In this case, the luminance adjustment value storage portion 25 stores the luminance adjustment value with the image as needed.

The controller 22 inputs the voltage control signal or a storage signal (storage completion signal) from the luminance adjustment value storage portion 25 and controls the entire apparatus based on these signals. On the other hand, the controller 22 changes the voltage based on the voltage control signal, and then controls the inspection apparatus to acquire again the reference image or the inspection image from the inspection microscope 1.

A specific processing of an inspection apparatus according to the present embodiment configured as above will be described.

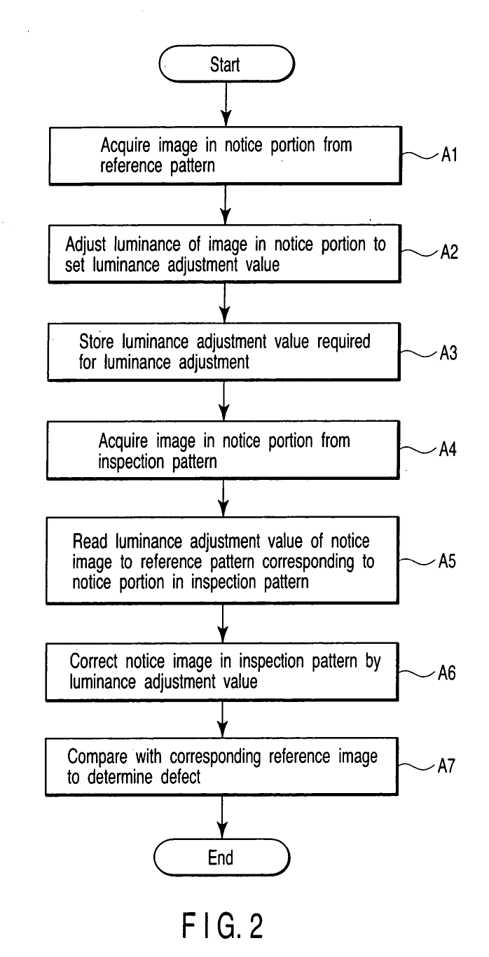

FIG. 2 is a flowchart of a luminance adjustment processing in a defect determination processing in the inspection apparatus. In the present embodiment, the following processing is basically performed for the luminance adjustment processing in the defect determination processing. At first, images in notice portions are acquired from a reference pattern image without defect, and a luminance adjustment value on the image in each notice portion is calculated and the luminance adjustment value corresponding to the image in each notice portion is stored. An inspection image is acquired and a notice portion in the reference pattern image corresponding to the notice portion of the inspection image is searched to correct the luminance of the inspection image based on the luminance adjustment value of the notice portion of the reference pattern image. The corrected inspection image and the reference pattern image are compared to make a defect determination. Specifically, the processing is as follows.

Initially, an image in each notice portion (hereinafter, referred to as “reference pattern notice image”) is acquired from the reference pattern image (step A1). Next, the luminance adjustment value setting portion 23 adjusts the luminance and makes it appropriate for the reference pattern notice image to set the luminance adjustment value to be calculated (step A2). The calculated luminance adjustment value for the reference pattern notice image is stored in the luminance adjustment value storage portion 25 (step A3). Steps A1 to A3 are performed for a plurality of notice images. Next, an image in a notice portion (hereinafter, referred to as “inspect pattern notice image”) is acquired form an inspection image pattern (step A4). Then, the controller 22 searches the reference pattern notice image corresponding to the acquired inspect pattern notice image, and reads out the luminance adjustment value corresponding to each searched reference pattern notice image from the luminance adjustment value storage portion 25 (step A5). The controller 22 corrects the luminance of the inspect pattern notice image according to the luminance adjustment value (step A6). The luminance of the inspection pattern notice image may be corrected by adjusting the luminance thereof according to a similar procedure to the method of setting the luminance adjustment value of the reference pattern notice image (step A2) and may be corrected by using the same value as the luminance adjustment value for the reference pattern notice image as it is. When the same value is used as it is, step A3 and step A5 can be omitted. The corrected inspect pattern image and the reference pattern image are compared and the controller 22 makes a defect determination (step A7).

If the luminance adjustment value is stored once to the luminance adjustment storage portion 25 (step A3), it is determined whether the luminance adjustment value is stored in the luminance adjustment storage portion 25 in the following defect determination flow of the inspection apparatus, and if the luminance adjustment value is stored, procedure may start from step A4.

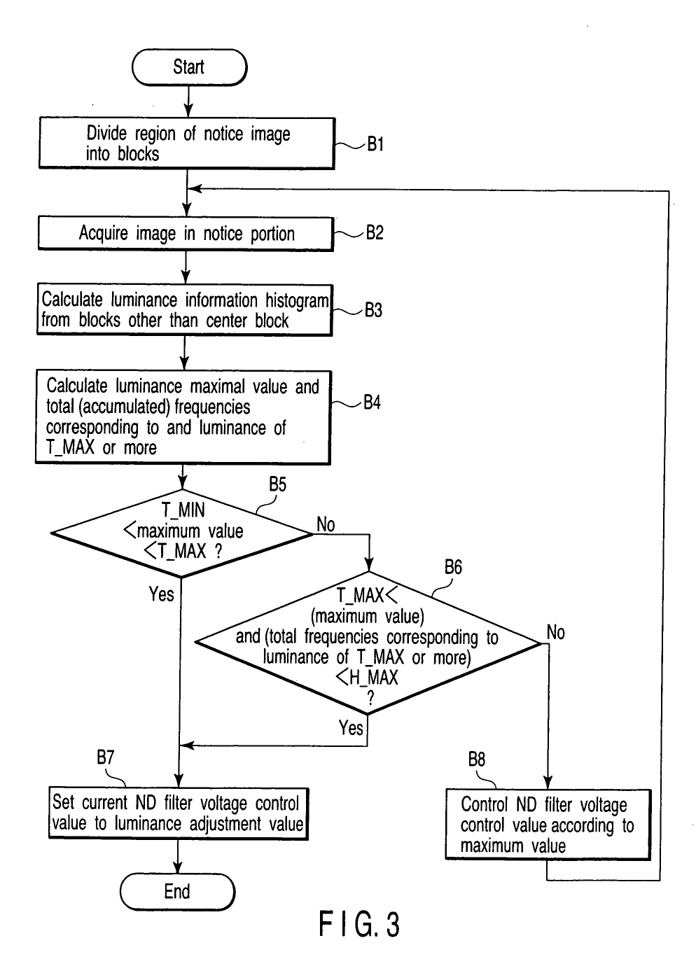

FIG. 3 is a flowchart showing details of a part where a luminance adjustment value is set from a reference pattern notice image in step A2 in the flow in FIG. 2. A value for adjusting the luminance will be described by way of example where a voltage control value for changing the transmittance of the ND filter 113 for inspection microscope 1 is used (the light amount of the light source itself may be adjusted). A method of changing a image-capturing condition is employed in FIG. 3, but a display condition may be changed to adjust the luminance without changing the image-capturing condition.

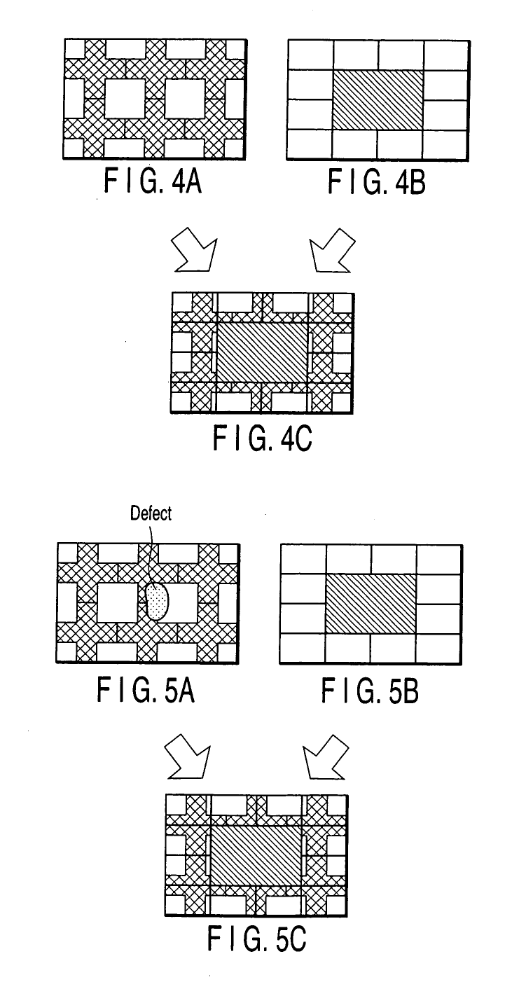

At first, a mask area is set such that an image in a defect portion, which is positioned at the center of view for the notice image, is not acquired. For example, a notice image is divided into a plurality of blocks, and blocks at the center where a defect portion is displayed are set as a mask area (step B1). The number of blocks in this case is not particularly limited, and, for example, the area is divided into 4×4 blocks and the 4 blocks at the center are set as the mask area. FIGS. 4B and 5B show the division examples. FIGS. 4A to 4C and 5A to 5C are explanatory diagrams of an image area used in histogram generation described later in detail. FIG. 4A shows a notice image in a reference pattern, and FIG. 5A shows a notice image of an inspection image when a defect is positioned substantially at the center.

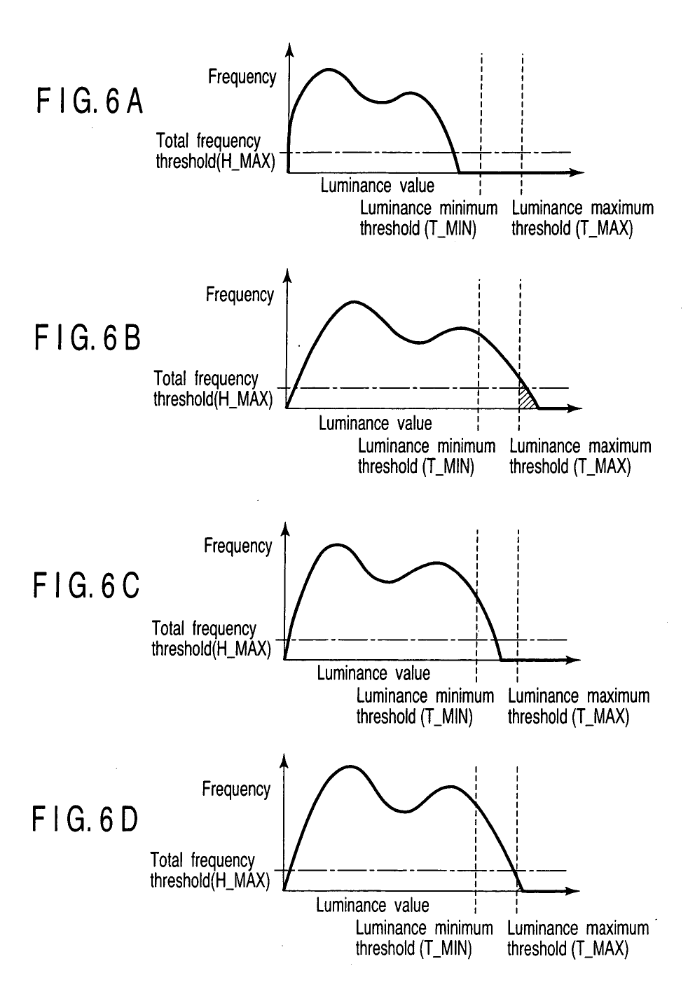

Next, a notice image is acquired (or read out) (step B2). Subsequently, as shown in FIGS. 4C and 5C, the divided blocks set in step B1 are allocated to the notice image. Luminance information is acquired from 12 blocks in the periphery other than the mask area at the center, and a histogram of the luminance information (that is, frequency for the luminance) is calculated (step B3). Here, the mask area at the center is removed when the luminance information is acquired for the following reason. When a defect on the wafer is captured by the inspection microscope 1, the defect is positioned at the center of view of the inspection microscope 1 (optical axis of the objective lens 12). Therefore, when the center of the inspection image is set as the mask area, the histogram of the luminance information can be calculated from the image information other than the center which does not contain a defect. Thus, it is possible to accurately set the luminance adjustment value for the inspection image without being affected by the defect. A histogram such as one shown in FIGS. 6A to 6D can be obtained. FIGS. 6A to 6D are diagrams showing the examples of various histograms. Since almost all the defects are displayed at the center of the inspection image which is the center of the view, a circular or rectangular mask area, which is larger than the defect, can be set at the center of this inspection image. Thus, the mask area may be set at the area where the defect of the inspection image is displayed, and may be set at a position other than the center.

Subsequently, the luminance maximum value and the total frequency (accumulated frequency) which is a threshold T_MAX or more (maximum limit of the luminance which is allowable as the luminance maximum value) are acquired from the generated histogram (step B4).

Next, it is checked whether the luminance maximum value is present between the threshold T_MAX and the threshold T_MIN (minimum limit of the luminance which is allowable as the luminance maximum value) (step B5).

In step B5, when the luminance maximum value is not present between the threshold T_MAX and the threshold T_MIN (No in step B5), a determination is made as to whether the luminance maximum value is larger than T_MAX and the accumulated frequency at the threshold T_MAX is smaller than H_MAX (threshold on the accumulated frequency) (step B6). In FIGS. 6A to 6D, the threshold H_MAX is set at a predetermined value such that an influence due to noise can be ignored.

In step B5, when the luminance maximum value is present between the threshold T_MAX and the threshold T_MIN as shown in FIG. 6C (Yes in step B5), the voltage control value of the ND filter 113, which is currently set, is set as the luminance adjustment value (that is, value capable of adjusting the luminance of the notice image to be appropriate) (step B7). Moreover, in step B6, when the luminance maximum value is larger than T_MAX and the accumulated frequency at the threshold T_MAX is smaller than the threshold H_MAX (threshold on the accumulated frequency) as shown in FIG. 6D (Yes in step B6), the voltage control value of the ND filter 113, which is currently set, is set as the luminance adjustment value as in the case of Yes in step B5 (step B7).

In the case of No in step B6, the ND filter 113 is controlled to change the voltage control value of the ND filter 113 according to the current luminance maximum value (step B8). Specifically, the processing is as follows.

Since, when the maximum value is T_MIN or less, the image is recognized to be too dark as shown in FIG. 6A, the voltage control value of the ND filter 113 is controlled (adjusted) to make brighter.

Since, when the maximum value is T_MAX or more and the accumulated frequency of the luminance, which is T_MAX or more, is H_MAX or more, the image is recognized to be too bright as shown in FIG. 6B, the voltage control value of the ND filter 113 is controlled (adjusted) to make darker.

After the voltage control value of the ND filter 113 is adjusted, the image at the same notice portion is again acquired.

In this case, the luminance adjustment value may be expressed as, for example, the characteristics when the luminance of the image is converted (linearly or non-linearly). For example, the luminance characteristics may be changed such that the frequency of the luminance indicating the bright portion and the frequency of the luminance indicating the dark portion are predetermined values or less, respectively (or the median or the mode value of the histogram are within a predetermined range). In this case, adjustment is possible by, for example, changing a gain or a γ coefficient. In this manner, the luminance of the image can be changed without changing the image-capturing condition, thereby performing a processing by software.

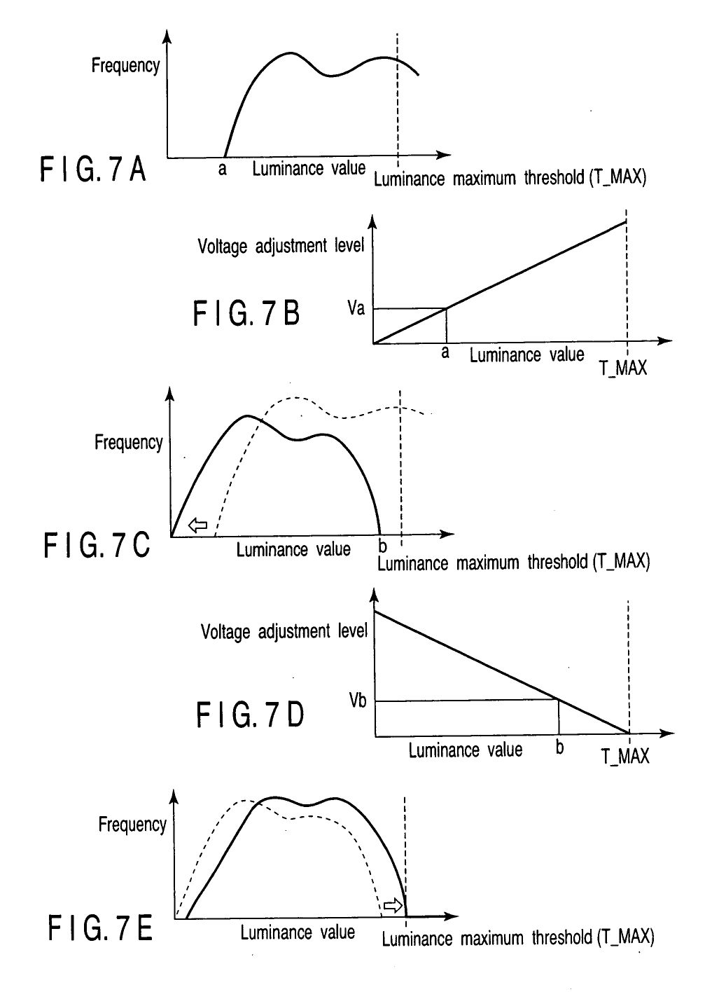

FIGS. 7A to 7E are diagrams showing other adjustment methods when the luminance adjustment value is set from the histogram. In the methods in FIG. 7A to 7E, only T_MAX is used as the threshold. The method has LUT (Look Up Table) where the voltage adjustment level and the luminance of the image are corresponded.

At first, it is assumed that the histogram as shown in FIG. 7A is obtained when the histogram of a notice image is acquired. In this case, the luminance maximum value exceeds the threshold T_MAX and an excessive light is incident into the pickup device. When the minimum luminance value in FIG. 7A is the luminance value “a”, the LUT shown in FIG. 7B is used to adjust the voltage adjustment level Va such that the minimum luminance value “a” is the luminance value 0.

As a result of the above voltage adjustment, the histogram of the notice image as shown in FIG. 7C is calculated. In the histogram shown in FIG. 7C, the maximum luminance value “b” is less than the threshold T_MAX. Thus, the LUT as shown in FIG. 7D is used to adjust the voltage adjustment level Vb at this time such that the maximum luminance value coincides with the threshold T_MAX. Thereby, the maximum luminance value “b” is coincided with the threshold T_MAX. Thereby, it is possible to obtain an optimum image for the defect inspect, which is brighter than the image which generates the histogram as shown in FIG. 7C.

The histogram as shown in FIG. 7E is finally calculated and the voltage adjustment level at this time may be set as the appropriate luminance adjustment value. When the histogram as shown in FIG. 7C is obtained when the first histogram is calculated, the LUT in FIG. 7D is used to perform the subsequent processing such that the maximum luminance value becomes appropriate. When the appropriate value is set as shown in FIG. 7E at the first stage, the voltage adjustment level at that time may be employed as the appropriate luminance adjustment value.

Moreover, in the case of the histogram in FIG. 7A, the voltage adjustment level may be adjusted by the LUT in FIG. 7B, and in the case of the histogram in FIG. 7E, the voltage adjustment level at that time may be set as the appropriate luminance adjustment value.

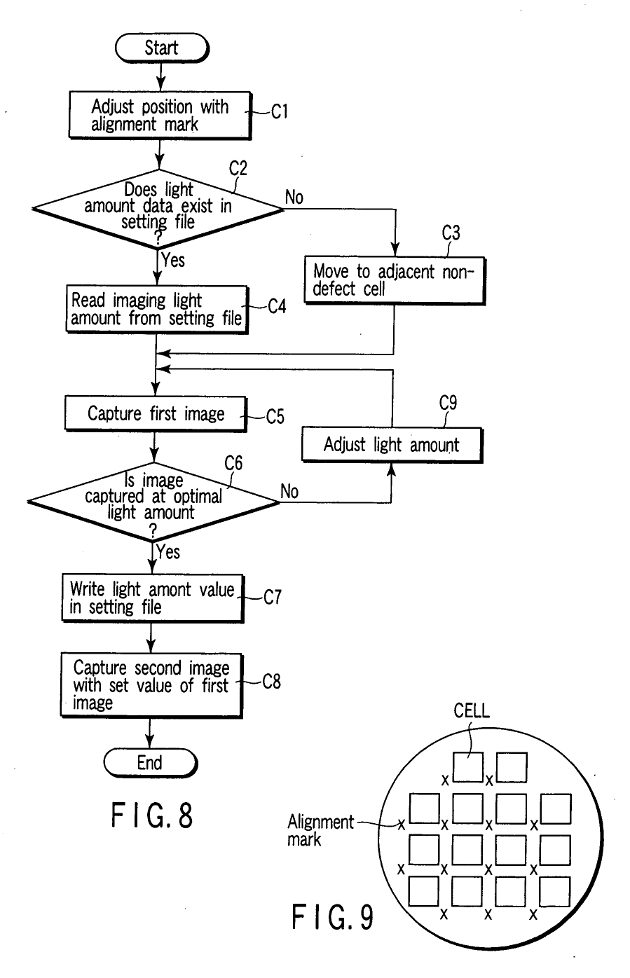

Next, the inspection apparatus according to another embodiment of the present invention will be explained referring to FIG. 8 and FIG. 9.

The wafer is put on an area, where an image is captured, of the microscope, and the inspection is started. First of all, a position matching of the wafer is performed. When the wafer is put on the area where the image captured, a precise position matching is not often performed usually. Therefore, the precise position matching is performed by using an alignment mark provided on the wafer (refer to FIG. 9). Shifts of position and rotation are corrected to set the wafer to the center position of the microscope by using two alignment marks or more (step C1).

Next, it is determined whether there is light amount data (luminance adjustment value) in the setting file (step C2). If there is no light amount setting data, it is moved to the non-defect cell which is adjacent to the alignment mark to acquire the first image (reference pattern notice image). Whether there is defect or not may be determined based on information from other defect inspection apparatuses and may be determined whether the luminance is within the range of a set value when the adjacent cell is captured (step C3). The data is read from the setting file if there is light amount setting data in step C2 (step C4). And then, the first image is captured (step C5). Whether the picked-up first image is captured by the optimal light amount or not is determined (step C6). In step C6, the determination is performed based on a range determined beforehand, for example, such as a range that the total light amount is within a certain range, or a range that luminance of a part of the image is within a certain range. If the light amount is not within the range, the light amount is adjusted, and the first image is captured again (step C9). In step C6, the light amount setting data of the first image used at that time is written in the setting file (luminance adjustment value storage portion 25) when total light amount is within the range (step C7). The second image (inspection pattern notice image) is captured by using the light amount setting data of the first image as it is (step C8). Since the light amount setting data of the first image thus (luminance adjustment value) is adjusted at the position matching, the moving time of the stage can be reduced. Since the light amount setting data of the first image is used as it is, the light amount setting data (luminance adjustment value) need not be set again when the second image (inspection pattern notice image) is acquired. Therefore, the inspection time can be reduced.

The following invention is extracted from each of the above embodiments. This invention is not limited to the above embodiments, and can be implemented by modifying the components without departing from the spirit when implementing the same. Appropriate combinations of several components disclosed in the above embodiments can form various inventions. For example, some components may be deleted from all the components shown in the embodiments. Furthermore, components over the different embodiments may be appropriately combined.

The inspection apparatus according to the embodiments of the present invention comprises a unit which uses image information on a first image (for example, a non-defect image such as reference image) to calculate a luminance adjustment value for adjusting a luminance of the first image at a desired value, a storage unit which stores the calculated luminance adjustment value, a unit which searches the first image which has image information corresponding to a second image (for example, inspected image) different from the first image, a unit which reads out a luminance adjustment value corresponding to the searched first image from the storage unit, and a unit which adjusts a luminance of the second image based on the luminance adjustment value read out from the storage unit. Preferably, the inspection apparatus further comprises a unit which uses the first image and the second image whose luminance is adjusted to perform inspecting. In this manner, in the inspect by image comparison, since a luminance adjustment value for adjusting the luminance of one image to be appropriate is obtained and a luminance of the other image is adjusted by the already adjusted luminance adjustment value, it is possible to observe and easily inspect both the images according to the appropriate luminance. Therefore, it is possible to perform accurate inspection (accurate detection of defect) by automatic inspection.

The following embodiments are preferable for the above inspection apparatus. The following embodiments may be applied independently or may be applied in appropriate combination.

(1) Image information used to calculate the luminance adjustment value is image information on the periphery of a first image. Generally, a defect is positioned at the center of the image. Therefore, the image information on the periphery is used to calculate the luminance adjustment value, thereby employing the defect image as the image for the first luminance adjustment. Even when the luminance adjustment value for the defect image is calculated, appropriate luminance adjustment can be performed without being affected by the defect.

(2) A unit which calculates the luminance adjustment value obtains a luminance of the image information on the first image and uses statistical information based on a histogram using the luminance to determine the luminance adjustment value. Here, the statistical information means the maximum value, the minimum value, the mode value, the median, and the like, and the actual image information is used, thereby optimizing the luminance adjustment value.

(3) The luminance adjustment value is at least one of a value indicating the characteristics for converting a tone of an image and a value indicating the control characteristics for adjusting a unit which determines brightness of the image. Since luminance adjustment of the image may be performed either by changing a capturing condition (that is, adjusting a mechanism for brightness in hardware) or by converting an image after capturing (that is, converting in software by image processing), the image-capturing system is changed to obtain more suitable image-capturing condition. Furthermore, when the image conversion is performed, the luminance adjustment irrespective of the apparatus configuration is enabled. The luminance adjustment in hardware may be performed in an applied voltage to an ND filter, light source voltage, or other light amount adjustment mechanism.

The luminance levels of the reference image and the inspected image are adjusted to be both appropriate, thereby providing the inspection apparatus capable of performing accurate inspection.

Additional advantages and modifications will readily occur to those skilled in the art. Therefore, the present invention in its broader aspects is not limited to the specific details, representative devices and illustrated examples shown and described herein. Accordingly, various modifications may be made without departing from the spirit or scope of the general inventive concept as defined by the appended claims and their equivalents.

1. An inspection apparatus comprising:
a unit which calculates a luminance adjustment value to adjust a luminance of a first image at a desired value by use of image information on the first image;
a storage unit which stores the calculated luminance adjustment value;
a unit which searches the first image having image information corresponding to a second image different from the first image;
a unit which reads out a luminance adjustment value corresponding to the searched first image from the storage unit; and
a unit which adjusts a luminance of the second image based on the luminance adjustment value read out from the storage unit.

2. The inspection apparatus according to claim 1, further comprising a unit which performs inspection by use of the first image and the second image whose luminance is adjusted.

3. The inspection apparatus according to claim 1, wherein the image information for use in calculation of the luminance adjustment value is image information on the periphery of the first image.

4. The inspection apparatus according to claim 1, wherein the unit which calculates the luminance adjustment value obtains a luminance of the image information on the first image and uses statistical information based on a histogram using the luminance to determine the luminance adjustment value.

5. The inspection apparatus according to claim 1, wherein the luminance adjustment value is at least one of a value indicating characteristics for converting a tone of the image and a value indicating control characteristics for adjusting a unit which determining brightness of the image.

6. The inspection apparatus according to claim 1, wherein the luminance adjustment value of the second image is same as the luminance adjustment value of the first image.

7. The inspection apparatus according to claim 1, wherein the first image is an image which is adjacent to a position matching mark.
